(19) United States
(12) Patent Application Publication
(10) Pub. No.: US 2012/0131957 A1
(43) Pub. Date: May 31, 2012

(54) Sheet Wafer Processing as a Function of Wafer Weight

(75) Inventors: Leo van Glabbeek, Franklin, MA (US); Gerald A. Simpson, JR., Auburn, MA (US); Soumana Hamma, Shrewsbury, MA (US); Stephen Yamartino, Wayland, MA (US)

(73) Assignee: Max Era, Inc., Marlborough, MA (US)

(21) Appl. No.: 13/249,798

(22) Filed: Sep. 30, 2011

Related U.S. Application Data
(60) Provisional application No. 61/388,920, filed on Oct. 1, 2010.

(51) Int. Cl. C03B 5/24; C03B 19/00

(52) U.S. Cl. 65/29.14; 65/29.21; 65/162

(57) ABSTRACT

A method and apparatus for forming a sheet wafer melts feedstock material in a crucible that is part of a crystal growth furnace, passes a plurality of filaments through the crucible to form a sheet wafer, and cuts a portion of the sheet wafer to form a smaller sheet wafer. The method and apparatus then determine the weight of the smaller sheet wafer, and control the temperature of the melted feedstock material (e.g., by controlling crucible temperature or by interfacing with another temperature control system) as a function of the determined weight.

### CROSS-REFERENCE TO RELATED APPLICATION(S)

This patent application claims the benefit of U.S. Provisional Patent Application No. 61/388,920 entitled METHOD AND APPARATUS FOR CONTROLLING WAFER PROCESSING AS A FUNCTION OF WAFER WEIGHT filed on Oct. 1, 2010, which is hereby incorporated herein by reference in its entirety.

### TECHNICAL FIELD

The invention generally relates to sheet wafers and, more particularly, the invention relates to fabrication of sheet wafers.

### BACKGROUND ART

Silicon wafers are the building blocks of a wide variety of semiconductor devices, such as solar cells, integrated circuits, and MEMS devices. For example, Evergreen Solar, Inc. of Marlboro, Mass. forms solar cells from silicon sheet wafers fabricated by passing two filaments through a crucible of silicon melt.

Continuous growth of silicon sheets eliminates the need for slicing of bulk produced silicon to form wafers. Two filaments of high temperature material are introduced up through the bottom of a crucible which includes a shallow layer of molten silicon, known as a “melt.” A seed is lowered into the melt, connected to the two filaments, and then pulled vertically upward from the melt. A meniscus forms at the interface between the bottom end of the seed and the melt, and the molten silicon freezes into a solid sheet just above the melt. The filaments serve to stabilize the edges of the growing sheet. U.S. Pat. No. 7,507,291, which is incorporated herein by reference in its entirety, describes a method for growing multiple filament-stabilized crystalline sheets simultaneously in a single crucible. Each sheet grows in a “lane” in the multi-lane furnace. The cost of fabricating wafers is thus reduced compared to crystalline sheet fabrication in a single-lane furnace.

Undesirably, like other wafer fabrication technologies, this wafer fabrication technique can produce defective wafers. For example, the wafers can be thicker or thinner than intended. If thinner, they can be quite fragile, thus reducing yield, or ultimately producing less efficient solar cells. If thicker, they may not be properly processed by downstream processes that are calibrated for thinner wafers. In addition, thicker wafers use more silicon feedstock, thus increasing fabrication costs. Dozens of furnaces in a factory, however, can produce thousands of wafers every hour. The furnace operators thus have limited time and resources to inspect every wafer.

This deficiency often results in large batches of defective wafers being integrated into products produced downstream in a device fabrication process. For example, a furnace could produce defective thin wafers for forty-eight hours. Those wafers could be processed into solar cells and assembled into solar panels. These downstream panels thus can be less efficient, more expensive to make, prone to breakage, and, sometimes, not usable.

### SUMMARY OF EXEMPLARY EMBODIMENTS

In accordance with one embodiment of the invention, a method and apparatus for forming a sheet wafer melts feedstock material in a crucible that is part of a crystal growth furnace, passes a plurality of filaments through the crucible to form a sheet wafer, and cuts a portion of the sheet wafer to form a smaller sheet wafer. The method and apparatus then weigh the smaller sheet wafer, and control the temperature of the melted feedstock material (e.g., by controlling crucible temperature) as a function of the weight.

A number of techniques control the temperature of the melted feedstock. Among others, the method and apparatus may determine that the weight is higher than an upper set weight point, and then increase the temperature of the melted feedstock in response to determining the weight is higher than the upper set weight point. Conversely, the method and apparatus may determine that the weight is lower than a lower set weight point, and then decrease the temperature of the melted feedstock in response to determining the weight is lower than the lower set weight point.

Some embodiments have a thickness detector to determine the thickness of the sheet wafer before cutting. The thickness is configured to control the melt temperature as a function of the thickness of the sheet wafer. In such case, the method and apparatus may control the temperature by forwarding a control signal to the thickness detector to cause the thickness detector to change the melt temperature.

The thickness detector may be configured to change the melt temperature when the wafer thickness is measured to be outside of a pre-selected thickness range. In that case, the method and apparatus may control the temperature by changing the pre-selected thickness range as a function of the weight of the smaller sheet wafer. For example, the pre-selected thickness range of the thickness detector may have an upper thickness and a lower thickness. The method and apparatus thus may control the temperature by increasing the upper thickness of the thickness range if the weight is below a lower set weight point. Alternatively, the method may control the temperature by reducing the lower thickness of the thickness range if the weight is above a higher set weight point. This thickness range may be a single thickness (i.e., both upper and lower thicknesses are the same) or between two set points.

In accordance with another embodiment of the invention, a method and apparatus for forming a sheet wafer melt feedstock material in a crucible that is part of a crystal growth furnace, pass a plurality of filaments through the crucible to form a sheet wafer, and use a thickness detector to measure the thickness of the growing sheet wafer. The thickness detector is calibrated to control the temperature of the melted feedstock as a function of the thickness. The method and apparatus then cut a portion of the sheet wafer to form a smaller sheet wafer, weight the smaller sheet wafer, and control the calibration of the thickness detector as a function of the weight of the smaller sheet wafer.

In accordance with other embodiments of the invention, a sheet wafer growth furnace system has a crucible, configured to contain melted feedstock, with a plurality of holes for passing a plurality of filaments through melted feedstock to form a sheet wafer. The system also has a separator for cutting a portion of the sheet wafer to form a smaller sheet wafer, a scale for weighing the smaller sheet wafer, and a controller (operatively coupled with the crucible) for controlling the temperature of the melted feedstock material as a function of the weight.

Illustrative embodiments of the invention may be implemented, at least in part, as a computer program product having a computer usable medium with computer readable program code thereon. The computer readable code may be read and utilized by a computer system in accordance with conventional processes.

Thus, embodiments of the invention may include a method of forming wafer products from a sheet wafer including melting feedstock material in a crucible that is part of a crystal growth furnace; passing a plurality of filaments through the crucible to form a sheet wafer; cutting a portion of the sheet wafer to form a smaller sheet wafer; weighing the smaller sheet wafer; controlling the temperature of the melted feedstock material as a function of the weight of the smaller sheet wafer.

In various alternative embodiments, the temperature may be controlled by increasing the temperature of the melted feedstock when the weight is above a predetermined upper threshold and/or by decreasing the temperature of the melted feedstock when the weight is below a predetermined lower threshold. The temperature may be controlled by controlling a crucible heating system. Additionally or alternatively, embodiments may measure the thickness of the sheet wafer before cutting by a thickness control system that is configured to control the melt temperature as a function of the thickness of the sheet wafer, such that the temperature may be controlled by forwarding a control signal to the thickness control system to cause the thickness control system to change the melt temperature. Such a thickness control system may be configured to change the melt temperature when the wafer thickness is measured to be outside of a pre-selected thickness range, such that the temperature may be controlled by changing the pre-selected thickness range as a function of the weight of the smaller sheet wafer. Such a pre-selected thickness range may have an upper thickness and a lower thickness, such that the temperature may be controlled by increasing the upper thickness of the thickness range if the weight is below a lower set weight point and/or by reducing the lower thickness of the thickness range if the weight is above a higher set weight point. The upper thickness of the pre-selected thickness range may be increased by shifting the pre-selected thickness range upward, and the lower thickness of the thickness range may be decreased by shifting the pre-selected thickness range downward. In certain embodiments, the thickness range may include substantially a single thickness.

Embodiments of the present invention also may include a method of forming a sheet wafer including melting feedstock material in a crucible that is part of a crystal growth furnace; passing a plurality of filaments through the crucible to form a sheet wafer; measuring the thickness of the sheet wafer using a thickness control system, the thickness control system being calibrated to control the temperature of the melted feedstock as a function of the thickness; cutting a portion of the sheet wafer to form a smaller sheet wafer; weighing the smaller sheet wafer; and controlling the calibration of the thickness control system as a function of the weight of the smaller sheet wafer.

In various alternative embodiments, the thickness control system may be calibrated to determine whether the sheet wafer has a pre-selected thickness, and the calibration may be controlled by decreasing the calibrated pre-selected thickness if the smaller sheet wafer has a weight that is greater than a pre-selected weight and/or increasing the calibrated pre-selected thickness if the smaller sheet wafer has a weight that is less than a pre-selected weight. The pre-selected thickness may be a thickness range or a single thickness. The pre-selected weight may be a weight range or a single weight.

Embodiments of the present invention also may include a sheet wafer growth furnace system including a crucible configured to contain melted feedstock, the crucible having a plurality of holes for passing a plurality of filaments through melted feedstock to form a sheet wafer; a separator for cutting a portion of the sheet wafer to form a smaller sheet wafer; a scale for weighing the smaller sheet wafer; and a controller, operatively coupled with the crucible, for controlling the temperature of the melted feedstock material as a function of the weight of the smaller sheet wafer.

In various alternative embodiments, the temperature may be controlled by increasing the temperature of the melted feedstock when the weight is above a predetermined upper threshold and/or by decreasing the temperature of the melted feedstock when the weight is below a predetermined lower threshold. The temperature may be controlled by controlling a crucible heating system. Additionally or alternatively, embodiments may include a thickness detector for measuring the thickness of the sheet wafer before cutting and providing thickness information for a thickness control system that is configured to control the melt temperature as a function of the sheet wafer thickness, such that the temperature may be controlled by recalibrating the thickness control system as a function of the weight of the smaller sheet wafer. Such a thickness control system may be configured to change the melt temperature when the wafer thickness is measured to be outside of a pre-selected thickness range, such that the temperature may be controlled by changing the pre-selected thickness range as a function of the weight of the smaller sheet wafer. Such a pre-selected thickness range may have an upper thickness and a lower thickness, such that the temperature may be controlled by increasing the upper thickness of the thickness range if the weight is below a lower set weight point and/or by reducing the lower thickness of the thickness range if the weight is above a higher set weight point. The upper thickness of the pre-selected thickness range may be increased by shifting the pre-selected thickness range upward, and the lower thickness of the thickness range may be decreased by shifting the pre-selected thickness range downward. In certain embodiments, the thickness range may include substantially a single thickness.

Additional embodiments may be disclosed and claimed.

### BRIEF DESCRIPTION OF THE DRAWINGS

Those skilled in the art should more fully appreciate advantages of various embodiments of the invention from the following “Detailed Description of Illustrative Embodiments,” discussed with reference to the drawings summarized immediately below.

FIG. 1 schematically shows a crucible growing a plurality of sheet wafers.

FIG. 2 schematically shows a furnace that can incorporate the crucible shown in FIG. 2. This furnace incorporates illustrative embodiments of the invention.

FIG. 3 shows a process of forming sheet wafers in accordance with illustrative embodiments of the invention.

It should be noted that the foregoing figures and the elements depicted therein are not necessarily drawn to consistent scale or to any scale. Unless the context otherwise suggests, like elements are indicated by like numerals.

### DETAILED DESCRIPTION OF ILLUSTRATIVE EMBODIMENTS

In illustrative embodiments, a method and apparatus control sheet wafer thickness as a function of wafer weight. To that end, various embodiments cut a smaller wafer from a growing sheet wafer, and weigh the newly cut wafer to determine if it falls within acceptable weight limits. If outside of acceptable limits, the method modifies the melt temperature in a manner that brings the wafer weight back within the acceptable limits. Details of illustrative embodiments are discussed below.

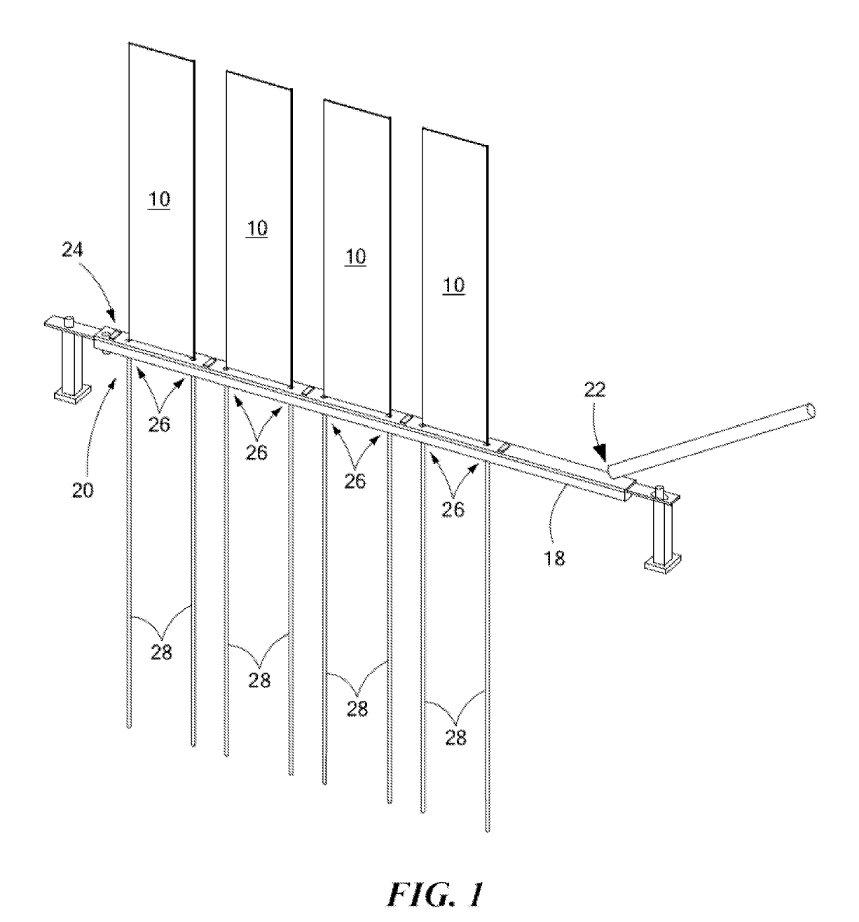

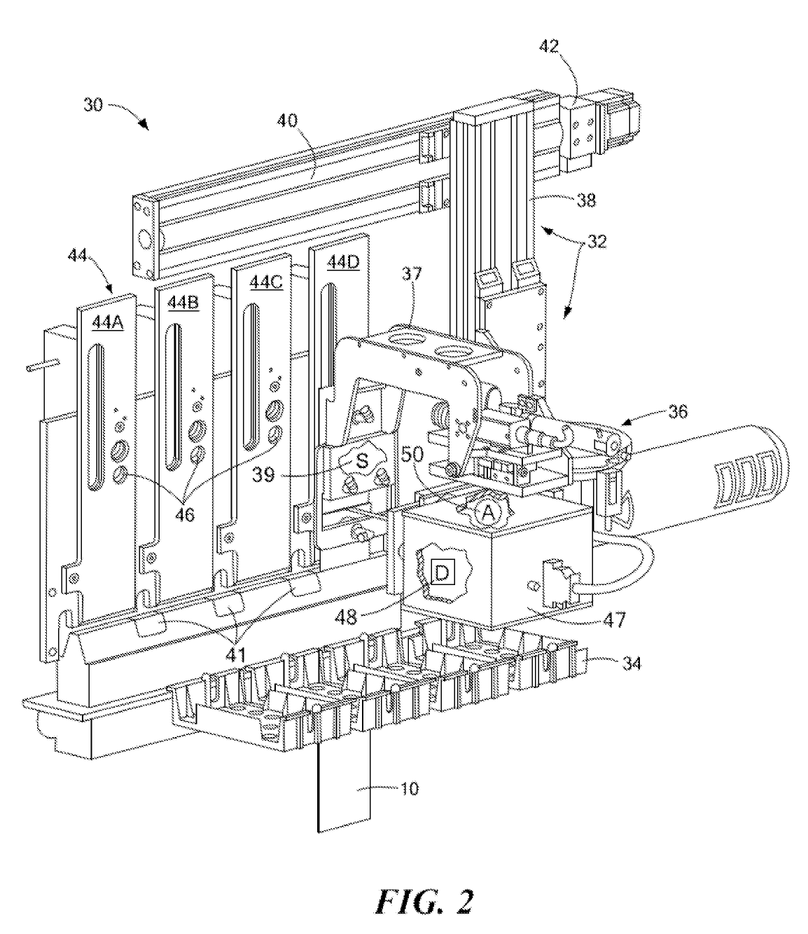

FIG. 1 schematically shows a multi-lane crucible 18 growing four sheet wafers 10, while FIG. 2 schematically shows a larger system that incorporates the crucible 18 of FIG. 1. This larger system also has a controller with defect logic 48 for controlling wafer thickness as a function of its weight. To those ends, this embodiment of the crucible 18 has an elongated shape with a region for growing multiple silicon sheet wafers 10 in a side-by-side arrangement along its length.

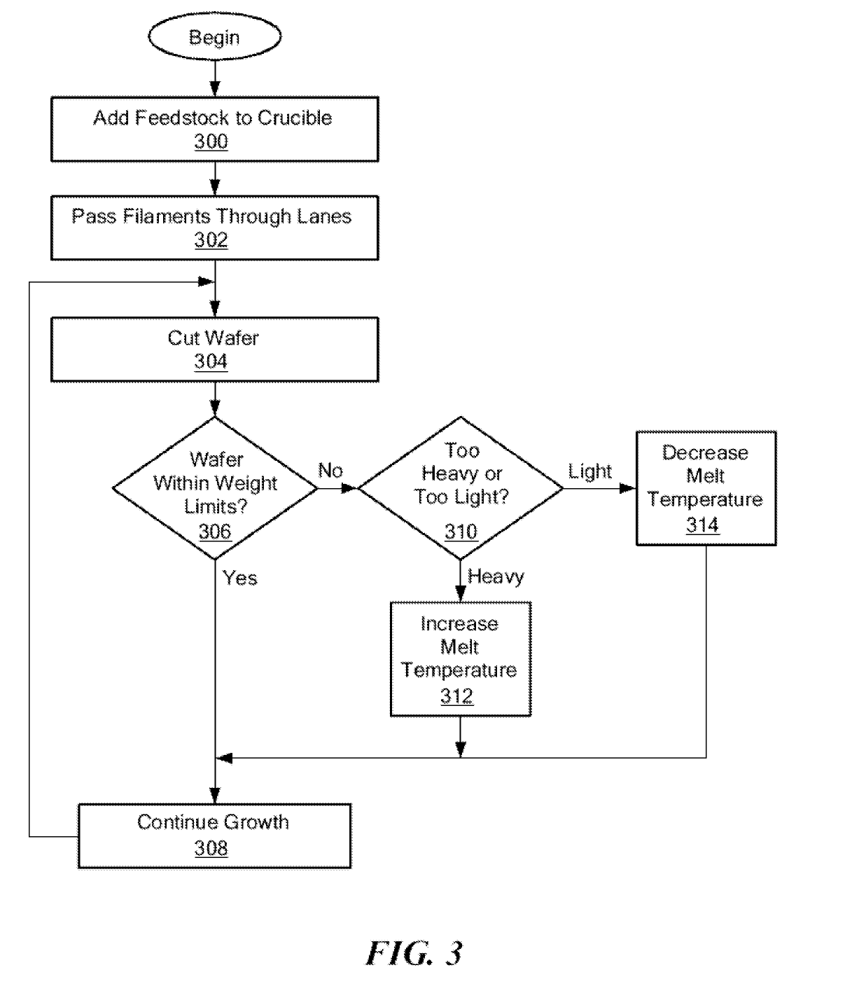

The crucible 18 of FIG. 1 is formed from graphite and resistively heated to a temperature capable of maintaining silicon above its melting point. As noted above, it is the crucible 18 that controls melt temperature. Thus, as discussed in greater detail below when discussing FIG. 3, the temperature of the crucible 18 is varied to control wafer thickness.

To improve results, the crucible 18 has a length that is much greater than its width. For example, the length of the crucible 18 may be three or more times greater than its width. Of course, in some embodiments, the crucible 18 is not elongated in this manner. For example, the crucible 18 may have a somewhat square shape, or a nonrectangular shape.

As shown, the crucible 18 has a feed inlet portion 22 for receiving polysilicon or other feedstock, a growth region 20 for growing four sheet wafers 10, and a melt dump region 24 for removing the melt. In addition, the crucible 18 has four pairs of filament openings 26, within the growth region 20, for receiving four pairs of filaments 28. Each pair of filaments 28 passes through the melted silicon in a controlled manner to form a growing sheet wafer 10. As discussed below, automated, computerized processes cut the growing sheet wafers 10 into smaller sheet wafers 10 as they move upwardly.

The crucible 18 is used as part of a process within a larger sheet wafer growth furnace 30, such as that shown in FIG. 2. For simplicity, the molten material discussed herein may be molten silicon. Of course, various embodiments of the invention may be applied to other molten materials. Moreover, those skilled in the art should understand that principles of various embodiments apply to furnaces that process more or fewer than four separate sheet wafers 10 and therefore can apply to furnaces having one or more lanes and/or to individual lanes of a multiple-lane furnace. For example, some embodiments apply to furnaces growing two sheet wafers 10 or six sheet wafers 10. Accordingly, discussion of a single furnace growing four sheet wafers 10 is for illustrative purposes only.

The furnace 30 has a movable assembly 32 for selectively separating (e.g., cutting) growing sheet wafers 10, and then weighing the separated portion (now in smaller wafer form since it is no longer growing) to determine if it is an appropriate weight. This separated portion, which forms a smaller wafer 10, then may be placed into a conventional tray 34. For example, the movable assembly 32 may process a first sheet wafer 10 by 1) separating a portion from the first sheet wafer 10 as it grows, 2) weighing it, and then 3) placing the separated portion in the tray 34. After placing the separated portion of the first sheet wafer 10 in the tray 34, the movable assembly 32 may repeat the same process with a second growing sheet wafer 10. This process may repeat indefinitely between the four growing sheet wafers 10 until some shut down or stoppage event (e.g., to clean the furnace 30 or to fix the furnace 30 after detecting a defective sheet wafer 10, such as those that are too heavy or too light). For convenience, the separated portions of sheet wafer may be referred to below as “wafer products” to distinguish them from the larger sheet wafer—generally speaking, it is these wafer products that are integrated into other products such as solar panels.

To perform this function, the movable assembly 32 has, among other things, a separation mechanism/apparatus (e.g., having a laser assembly 36, discussed immediately below) for separating a portion of the sheet wafer 10, and a rotatable robotic arm 37 for grasping both smaller wafers 10 (as they are removed) and growing sheet wafers 10, and positioning the grasped wafers 10 in the tray 34. Consequently, the furnace 30 may substantially continuously produce silicon wafers 10 without interrupting the crystal growth process. Some embodiments, however, can cut the sheet wafers 10 when crystal growth has stopped.

To those ends, the movable assembly 32 also may include a laser assembly 36 that, along with the rest of the movable assembly 32, is vertically movable along a vertical stage 38, and horizontally movable along a horizontal stage 40. Conventional motorized devices, such as stepper motors (one of which is shown and identified by reference number 42), control movement of the movable assembly 32. For example, a vertical stepper motor (not shown) vertically moves the movable assembly 32 as a function of the vertical movement of a growing wafer 10 (discussed in greater detail below). A horizontal stepper motor 42 moves the assembly 32 horizontally. Of course, as noted, other types of motors may be used and thus, discussion of stepper motors is illustrative and not intended to limit all embodiments.

The flexibility afforded by the vertical and horizontal stages 38 and 40 enables the laser assembly 36 to serially cut multiple growing sheet wafers 10. In illustrative embodiments, the vertical and horizontal stages 38 and 40 are formed primarily from aluminum members that are isolated from the silicon, which can be abrasive. Specifically, exposing the stages 38 and 40 to silicon could impair and degrade their functionality. Accordingly, illustrative embodiments seal and pressurize the stages 38 and 40 to isolate them from the silicon in their environment.

The furnace 30 also has guide assembly 44 with four separate guides 44A-44D (i.e., one for each growth channel) for simultaneously growing four separate sheet wafers 10. When referenced individually or collectively without regard to a specific channel, a guide will be generally identified by reference number 44. For illustrative purposes, a single sheet wafer 10 is shown in guide/channel 44D, although typically there would be sheet wafers 10 in each of the guides/channels 44.

Each guide 44, which is formed primarily from graphite, produces a very light vacuum along its face. This vacuum causes the growing sheet wafer 10 to slide gently along the face of the guide 44 to prevent the sheet wafer 10 from drooping forward. To that end, illustrative embodiments provide a port on the face of each guide 44 for generating a Bernoulli vacuum having a pressure on the order of about 1 inch of water.

Each guide 44 also has a wafer detect sensor 46 for detecting when the growing sheet wafer 10 reaches a certain height/length. As discussed below, the detect sensors 46 each produce a signal that controls processing by, and positioning of, the movable assembly 32. Specifically, after detecting that a given sheet wafer 10 has reached a certain height/length, the detect sensor 46 on a given guide 44 monitoring the given sheet wafer 10 forwards a prescribed signal to logic that controls the movable assembly 32. After receipt, the movable assembly 32 should move horizontally to the given guide 44 to produce a smaller wafer 10. Of course, the movable assembly 32 may be delayed if requests from sensors 46 at other guides 44/channels have not been sufficiently serviced.

Many different types of devices may be used to implement the functionality of the detect sensor 46. Vision systems are one type. For example, a retro-reflective sensor, which transmits an optical signal and measures resultant optical reflections, should provide satisfactory results. As another example, an optical sensor having separate transmit and receive ports also may implement the detect sensor functionality. As yet another example, the vision systems may include a low cost line scan camera. Other embodiments may implement non-optical sensors.

The movable assembly 32 therefore moves to the appropriate guide 44 in response to detection by the detect sensor 46. In this manner, the movable assembly 32 is capable of serially processing and cutting the four growing sheet wafers 10. It should be noted that illustrative embodiments apply to other configurations and, as suggested above, to different numbers of guides 44/channels. Discussion of four side-by-side guides 44 thus is for illustrative purposes only. For additional details of various embodiments of the furnace 30, see United States Published Patent Application No. US-2008-0102605-A1 corresponding to co-pending U.S. patent application Ser. No. 11/925,169 (attorney docket number 3253/130), which is incorporated herein, in its entirety, by reference.

The various operations of the furnace, such as monitoring wafer position via the sensors 46 and operating the assembly 32 to cut wafer products from the various lanes, are generally managed by a controller 47 that includes appropriate hardware and/or software logic.

As mentioned above, various embodiments weigh the wafer product to determine if it falls within acceptable weight limits. If outside of acceptable limits, the melt temperature is modified in a manner that brings the wafer product weight back within the acceptable limits. As known by those in the art, cooling the melt increases the thickness of a sheet wafer 10, while heating the melt decreases the thickness of a sheet wafer 10. Thus, if the wafer product is too heavy (implying that the wafer is too thick), then the melt temperature is increased. If the wafer product is too light (implying that the wafer is too thin), then the melt temperature is decreased. These temperature changes are generally done incrementally in what essentially is a closed loop control system.

Thus, in exemplary embodiments, the system has at least one a scale 39 to weigh removed sheet wafers 10. The scale 39 may be integrated into the movable assembly 32. e.g., to weight the sheet wafers as they are removed. Alternatively, the scale 39 may be on another part of the furnace 30 or may be external to the furnace 30. In any case, the scale 39 is electrically connected to the furnace 30 and in particular to defect logic 48 (shown here as part of the controller 47) that monitors the weight of the wafer products and controls melt temperature, as discuss in greater detail below.

In certain exemplary embodiments, the defect logic 48 may control the melt temperature by directly interfacing with a crucible heating system (e.g., with a heater in the melt or the crucible heating control circuitry, not shown). In other exemplary embodiments, the defect logic 48 may control the melt temperature by leveraging other temperature control systems in the furnace 30. In any case, controlling the temperature of the melt implies controlling the temperature of the apparatus that controls the melt temperature; in this case, controlling the melt temperature essentially means controlling the temperature of the crucible 18.

Typically, melt temperature in the furnace 30 is controlled at least in part based on the thickness of the sheet wafer, and in certain exemplary embodiments, the defect logic 48 may interface with the thickness control system to control melt temperature based on the weight of the wafer products. For example, to help monitor and control wafer thickness (i.e., to produce wafers that are within a predetermined thickness range), each lane of the furnace 30 typically has a local thickness detector 41 (shown generically as a box in FIG. 2) for determining the thickness of the growing sheet wafers 10, with control logic (which may be part of the controller 47) for controlling the thickness detector calibration point as a function of the measured wafer thickness. Specifically, as discussed in greater detail below with reference to FIG. 3, the thickness detector 41 measures the thickness one or both edges of the growing sheet wafer 10. In turn, the thickness detector calibration points are used by the thickness detector control logic determine whether the sheet wafer is within the predetermined thickness range, and if not, to control the melt temperature, e.g., by interfacing directly or indirectly with the crucible heating system (e.g., with a heater in the melt or the crucible heating control circuitry, not shown).

Many types of thickness detectors should suffice. For example, one thickness detector that has provided excellent results has a light emitting diode on one side/face of the sheet wafer 10, and a sensor on the opposite side/face of the sheet wafer 10. The thickness of the sheet wafer 10 is related to the amount of the diode light emitted through the sheet wafer 10. Thus, the sensor detects the light through the wafer 10 and consequently determines wafer thickness.

As discussed above, cooling the melt increases the thickness of a sheet wafer 10, while heating the melt decreases the thickness of a sheet wafer 10. Accordingly, if the thickness detector 41 determines that the thickness is too high, it automatically heats the crucible 18 to heat the silicon melt. Conversely, if it determines that the thickness is too low, then the thickness detector 41 automatically cools the crucible 18 (e.g., it may simply not apply a heat signal to the crucible 18 for a set period) to cool the melt.

To those ends, the thickness detector 41 is calibrated with data representing a desired thickness range. For example, that thickness range can be a single value (e.g., 195 microns), or between two values (e.g., between 190 microns and 195 microns).

In accordance with illustrative embodiments of the invention, the defect logic 48 can change that calibration as a function of the weight of the sheet wafer 10. For example, if the sheet wafer 10 is too light, then the defect logic 48 may cause the crucible 18 to cool by increasing the calibrated range (e.g., increasing a 195 micron thickness limit to 196 microns). Conversely, if the sheet is too heavy, then the defect logic 48 may cause the crucible 18 to heat by decreasing the calibrated range (e.g., decreasing a 190 micron thickness limit to 189 microns). Alternatively, the defect logic 48 simply may shift the entire thickness range between upper and lower thicknesses (e.g., the five micron range) up or down (e.g., a range of 190-195 microns may be increased to 191-196 microns or decreased to 189-194 microns).

Those skilled in the art know that the cross-sectional thickness of a sheet wafer varies. For example, in some spots, a sheet wafer could be as thick as 195 microns (e.g., near the edges), while in other spots, it could be as thin as 140 microns (e.g., near the center). The diode-based thickness detector 41 noted above is stationary in that it measures thickness through a single spot, typically near the wafer edge, with the wafer moving past the thickness detector 41 so that the thickness can be measured along the length of the sheet wafer. Thus, if the defect logic 48 increases or decreases the thickness range, then the wafer changes in a similar manner across its profile. For example, a change in the thickness range that results in an increase in thickness at the edge of the sheet wafer from 195 microns to 196 microns might cause a corresponding 1-2 micron thickness change nearer the center of the wafer 10 (e.g., the center could change from 140 microns to 141 microns). In any event, the increase or decrease of the wafer thickness will correspondingly increase or decrease the average thickness across the wafer 10.

The inventors anticipate that the defect logic 48 will recalibrate the thickness detector 41 in small increments. Specifically, in some sheet wafer furnaces known the art, a 1 degree C. change in melt temperature causes a change in wafer thickness on the order of about 25 microns. Accordingly, changes in the crucible/melt temperature can be made in very small increments, such as in tenths or hundredths of a degree C.

It should be noted that the defect logic 48 may initiate a change in melt temperature based on weight measurements even if the wafer products are within the specified valid weight range. For example, the defect logic 48 may initiate a change in melt temperature if the weight of the wafer products is nearer to one weight limit than the other weight limit (e.g., to try to keep wafer weight/thickness around a nominal value for consistency or to reduce the chances that some wafer products will fall outside of the valid weight range due to typical process variations) or if the weights of the wafer products measured over time is trending toward one or the other weight limit (e.g., to make corrections before the wafer products go “out-of-spec”).

As noted herein, the defect module 48 can attend to a wafer 10 in one lane of a multiple-lane furnace (e.g., weighing a wafer product, controlling melt temperature, etc.) while wafer growth continues in the other lanes.

In addition, the furnace 30 also may include an alarm module 50 (shown here as part of the controller 47) that generates indicia relating to the wafer fabrication process generally and to the weight-based aspects in particular. For example, the indicia may include such things as an audio signal (e.g., an alarm), a visual signal (e.g., a flashing light or red light), an electronic message to a control console or hand-held device controlled by the operator, and/or a log file. The indicia may include any of a variety of process information, such as, for example, an indication that an error condition occurred (e.g., an “out-of-spec” wafer product was detected), an indication that an error condition is approaching (e.g., the weights of the wafer products are trending toward a limit), the lane in which a condition was detected, the weights of wafer products produced in a lane, the number of valid and invalid wafer products produced, etc.

FIG. 3 shows a process of forming a plurality of wafers 10 of the multi-lane furnace 30 in accordance with illustrative embodiments of the invention. It should be noted that for simplicity, this described process is a significantly simplified version of an actual process used to form a plurality of growing sheet wafers 10 in a multi-lane furnace 30. Accordingly, those skilled in the art would understand that the process will have additional steps not explicitly shown in FIG. 3. Moreover, some of the steps may be performed in a different order than that shown, or at substantially the same time. Those skilled in the art should be capable of modifying the process to suit their particular requirements without undue experimentation.

The process begins at step 300, which adds feedstock to the crucible 18. Among other materials, the feedstock may include polysilicon pellets coated with a p-type dopant, such as boron. Next, step 302 passes filaments 28 through the filament openings 26 in the crucible 18 and the polysilicon melt to form a plurality of simultaneously growing sheet wafers 10 across the four lanes. Seeding and other startup techniques known to those skilled in the art also are performed. Both steps 300 and 302 are conventional.

At some point, the process cuts each growing sheet wafer 10 into smaller sheet wafers 10, at step 304. Accordingly, the movable assembly 32 with the laser assembly 36 cuts the wafers 10 in a conventional manner. Step 306 then determines if a given wafer 10 (of the specific lane) is within pre-specified weight limits. To that end, the scale 39 weighs the cut wafer 10, and delivers a message to the defect logic 48 having information relating to the wafer weight. The defect logic 48 then determines if the weight is within a prescribed weight range extending between a high weight limit and a low weight limit or otherwise indicates that action is required (e.g., trending toward a limit). It should be noted that the scale 39 may provide the defect logic 48 with an absolute weight of the cut wafer 10, a relative weight of the cut wafer 10, or an indication of whether the cut wafer 10 is within the prescribed weight range or alternatively whether the weight of the cut wafer 10 is below the low weight limit or above the high weight limit.

If within the weight limits with no temperature change required based on the weight (Yes in step 306), then normal growth continues to step 308, in which the movable assembly 32 places the newly separated wafer 10 in the tray 34. Alternatively, if step 306 determines that the wafer 10 is not within prescribed weight limits or that a temperature change is otherwise required based on the weight, then the process continues to step 310, in which the defect logic 48 determines if the wafer 10 is too heavy or too light (e.g., which prescribed weight limit the wafer 10 exceeds).

If too heavy, then the process continues to step 312, which increases the melt temperature. For example, as described above, the defect logic 48 may recalibrate the thickness detector 41 to increase the melt temperature, e.g., by shifting the calibrated thickness range of the thickness detector 41 downwardly or by directly controlling the crucible heating system. Conversely, if the wafer 10 is too light, then the process continues to step 314, which decreases the melt temperature. For example, the defect logic 48 may recalibrate the thickness detector 41 to decrease the melt temperature, e.g., by shifting the calibrated thickness range of the thickness detector 41 upwardly or by directly controlling the crucible heating system.

After either of steps 312 and 314, the process continues normal sheet wafer growth at step 308.

In addition to, or in lieu of, controlling melt temperature, the alarm module 50 may produce indicia as discussed above, e.g., to notify an operator in some manner of relevant process information. After receiving this notification, the operator can take appropriate action, e.g., to locate and fix the source of the defects. For example, the operator can take any of the following remedial actions:
verify the thickness detector 41 settings,
check for dust or silicon debris in the chimney of the furnace 30, which can compromise readings of the thickness detector 41,
check gas flows in gas jets, if the furnace 30 has gas jets cooling growing wafers 10,
run internal test of the system,
ensure that the heat profile of the furnace 30 matches the intended specification,
monitor tension of the filaments 28 passing through the filament openings 26,
determine if the furnace 30 is due for a cleaning,
look for loose or broken debris, such as broken filaments 28, in the melt,
analyze thickness profile of the wafer 10,
confirm that the melt height is neither too high nor too low, and/or
check/adjust the melt temperature.

It should be understood that this list of remedial options is not complete and, thus, the operator may take other remedial steps in response to an alarm condition. Additionally or alternatively, some of these remedial actions may be initiated/performed automatically by the system, e.g., in response to the defect logic 48 or alarm module 50.

Some embodiments do not perform both the process control functions and producing indicia based on the weight measurements. Instead, some embodiments only perform the process control functions (e.g., adjust the melt temperature based on the weight measurements), while other embodiments only produce the indicia, e.g., to notify an operator who can then adjust the temperature. Some embodiments allow these functions to be selectively performed, e.g., allowing the operator to configure whether one, the other, neither, or both are performed. Thus, at least internally, the system produces an output signal that can be used to drive the alarm module 50 and/or the temperature control decision.

Accordingly, various embodiments offer an effective technique for ensuring that the sheet wafer has appropriate size and weight.

Various embodiments of the invention may be implemented at least in part in a conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, at least part of the disclosed apparatus and methods may be implemented as a computer program product for use with a computer system. Such implementation may include a series of computer instructions fixed either on a tangible medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of forming wafer products from a sheet wafer, the method comprising:
melting feedstock material in a crucible that is part of a crystal growth furnace;
passing a plurality of filaments through the crucible to form a sheet wafer;
cutting a portion of the sheet wafer to form a smaller sheet wafer;
weighing the smaller sheet wafer; and
controlling the temperature of the melted feedstock material as a function of the weight of the smaller sheet wafer.

2. The method as defined by claim 1 wherein controlling the temperature comprises at least one of:
increasing the temperature of the melted feedstock when the weight is above a predetermined upper threshold; and
decreasing the temperature of the melted feedstock when the weight is below a predetermined lower threshold.

3. The method as defined by claim 1 wherein controlling the temperature comprises controlling a crucible heating system.

4. The method as defined by claim 1 further comprising:
measuring the thickness of the sheet wafer before cutting by a thickness control system, the thickness control system being configured to control the melt temperature as a function of the thickness of the sheet wafer,
wherein controlling the temperature comprises forwarding a control signal to the thickness control system to cause the thickness control system to change the melt temperature.

5. The method as defined by claim 4 wherein the thickness control system is configured to change the melt temperature when the wafer thickness is measured to be outside of a pre-selected thickness range, and wherein controlling the temperature comprises changing the pre-selected thickness range as a function of the weight of the smaller sheet wafer.

6. The method as defined by claim 5 wherein the pre-selected thickness range has an upper thickness and a lower thickness, and wherein controlling the temperature comprises at least one of:
increasing the upper thickness of the thickness range if the weight is below a lower set weight point; and
reducing the lower thickness of the thickness range if the weight is above a higher set weight point.

7. The method as defined by claim 6, wherein:
increasing the upper thickness of the thickness range comprises shifting the pre-selected thickness range upward; and
decreasing the lower thickness of the thickness range comprises shifting the pre-selected thickness range downward.

8. The method as defined by claim 5 wherein the thickness range comprises substantially a single thickness.

9. A method of forming a sheet wafer, the method comprising:
melting feedstock material in a crucible that is part of a crystal growth furnace;
passing a plurality of filaments through the crucible to form a sheet wafer;
measuring the thickness of the sheet wafer using a thickness control system, the thickness control system being calibrated to control the temperature of the melted feedstock as a function of the thickness;
cutting a portion of the sheet wafer to form a smaller sheet wafer;
weighing the smaller sheet wafer; and
controlling the calibration of the thickness control system as a function of the weight of the smaller sheet wafer.

10. The method as defined by claim 9 wherein the thickness control system is calibrated to determine whether the sheet wafer has a pre-selected thickness, and wherein controlling the calibration comprises at least one of:
decreasing the calibrated pre-selected thickness if the smaller sheet wafer has a weight that is greater than a pre-selected weight; and
increasing the calibrated pre-selected thickness if the smaller sheet wafer has a weight that is less than a pre-selected weight.

11. The method as defined by claim 10 wherein the pre-selected thickness is one of a thickness range and a single thickness.

12. The method as defined by claim 10 wherein the pre-selected weight is one of a weight range and a single weight.

13. A sheet wafer growth furnace system comprising:
a crucible configured to contain melted feedstock, the crucible having a plurality of holes for passing a plurality of filaments through melted feedstock to form a sheet wafer;
a separator for cutting a portion of the sheet wafer to form a smaller sheet wafer;
a scale for weighing the smaller sheet wafer; and
a controller, operatively coupled with the crucible, for controlling the temperature of the melted feedstock material as a function of the weight of the smaller sheet wafer.

14. The system as defined by claim 13 wherein the controller is configured to control the temperature by at least one of:
increasing the temperature of the melted feedstock when the weight is higher than an upper set weight point; and
decreasing the temperature of the melted feedstock when the weight is lower than a lower set weight point.

15. The system as defined by claim 13 wherein the crucible is associated with a crucible heating system, and wherein the controller is configured to control the temperature of the melted feedstock by controlling a crucible heating system.

16. The system as defined by claim 13 further comprising:
a thickness detector for measuring the thickness of the sheet wafer before cutting and providing thickness information for a thickness control system that is configured to control the melt temperature as a function of the sheet wafer thickness, the controller configured to recalibrate the thickness control system as a function of the weight of the smaller sheet wafer.

17. The system as defined by claim 16 wherein the thickness control system is configured to change the melt temperature when the wafer thickness is measured to be outside of a pre-selected thickness range, and wherein the controller is configured to change the pre-selected thickness range as a function of the weight of the smaller sheet wafer.

18. The system as defined by claim 17 wherein the pre-selected thickness range has an upper thickness and a lower thickness, and wherein the controller is configured to change the pre-selected thickness range by at least one of:
increasing the upper thickness of the thickness range if the weight is below a lower set weight point; and
reducing the lower thickness of the thickness range if the weight is above a higher set weight point.

19. The system as defined by claim 18, wherein:
increasing the upper thickness of the thickness range comprises shifting the pre-selected thickness range upward; and
decreasing the lower thickness of the thickness range comprises shifting the pre-selected thickness range downward.

20. The system as defined by claim 17 wherein the thickness range comprises substantially a single thickness.
